(19) United States
(12) Patent Application Publication
(10) Pub. No.: US 2008/0055724 A1
(43) Pub. Date: Mar. 6, 2008

(54) OPTICAL DEVICES CONTAINING BIREFRINGENT POLYMER FIBERS

(75) Inventors: Gregory L. Bluem, St. Paul, MN (US); Huiwen Tai, Woodbury, MN (US); Patrick R. Fleming, Lake Elmo, MN (US); Daniel J. Zillig, Cottage Grove, MN (US); Joan M. Frankel, Woodbury, MN (US); Robert L. Brott, Woodbury, MN (US); William J. Kopecky, Hudson, WI (US); Shandon D. Hart, Maplewood, MN (US); Kristin L. Thunhorst, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/468,737

(22) Filed: Aug. 30, 2006

(51) Int. Cl. G02B 5/30

(52) U.S. Cl. 359/497

(57) ABSTRACT

A display system has a display panel and at least one light source for producing light to illuminate the display panel. A polarizer film may be employed between the display panel and the light source. At least one of the polarizing fibers has multiple internal birefringent interfaces between a first polymer material and a second polymer material. In some embodiments, the polarizer substantially reflects normally incident light in a first polarization state and substantially transmits normally incident light, in a second polarization state orthogonal to the first polarization state, with a haze value of at least 10%.

### FIELD OF THE INVENTION

The invention relates to optical display systems, and more particularly to optical display films that contain polarizing films.

### BACKGROUND

Liquid crystal display (LCD) devices typically are assembled with a backlight, which generates illumination light, disposed behind a liquid crystal panel. Since it is important that the liquid crystal panel is uniformly illuminated, a diffuser plate is often used to diffuse the illumination light. This is especially important where the light sources, conventionally elongated fluorescent lamps that stretch across the LCD, are disposed behind the display panel. The diffuser plate is often a few millimeters thick and backscatters a significant fraction of the much of the incident light back to the lamps. A reflector disposed behind the lamps is used to redirect the backscattered light towards the display panel. Thus, a “cavity” is formed between the diffuser plate and the reflector which permits multiple reflections/scattering events so that the light can spread out between the lamps. The diffuser plate may contain printed features using reflective or diffusive ink to increase the uniformity of the light. Typical diffuser plates are made of a very clear plastic such as PMMA, polycarbonate, methyl-styrene, polystyrene polymers or blends of such polymers, that are filled with diffusing particles. These plastics have excellent optical properties, but often sub-optimal mechanical and thermal properties. They may distort under high heat loads, are prone to turning yellow under the intense light (visible or ultraviolet) from the lamps, and warp under conditions of differential humidity and temperature. All of these effects cause undesirable effects in the image of the display. There is thus a need for LCD components with improved thermal, mechanical, and dimensional stability features, while retaining the desired optical properties. A second, thin sheet of diffuser material is typically placed above the diffuser plate for further shaping the light output.

It is typical to use a number of different light management films between the diffuser plate and the light panel. One such film is a prismatic brightness enhancing film that redirects light propagating in a direction far from normal into a direction closer to the normal. Thus, more light is collimated into the angular space viewed by the viewer, and the image appears brighter. A reflective polarizing film is typically used above the brightness enhancing film. This reflective polarizer transmits only light in the polarization state that is used by the display panel, and reflects light in the orthogonal polarization state back towards the lamps. The reflected light is recycled by the reflector and returns to the reflective polarizer in a polarization state that is at least partially altered, so that a fraction of the originally reflected light can pass to the display panel. The reflective polarizing film may be unstable under high heat and illumination conditions; it may warp badly when placed in a hot backlight system. In large sizes, the reflective polarizer may not be stiff enough to remain flat when placed as a loose sheet in a backlight, leading to visible non-uniformities in the display. Increased stiffness also leads to ease of handling and less likelihood of film damage during assembly. The materials used to make the reflective polarizer may be sensitive to UV light. In an attempt to overcome these fundamental problems, the polarizing film is often laminated between two sheets of heavy optical plastic, typically polycarbonate that is 125-250 microns thick. This lamination step adds additional cost and weight to the construction.

It is desirable to reduce the number of films used in a display system and to make the films in the display system more able to operate under the conditions of heat and humidity experienced by displays when operated.

### SUMMARY OF THE INVENTION

One embodiment of the invention is directed to an optical display system that has a display panel and at least one light source for producing light to illuminate the display panel. One or more light management films are disposed between the light source and the display panel. One such film is a polarizer film that has polarizing fibers embedded within a matrix. At one of the polarizing fibers has multiple internal birefringent interfaces between a first polymer material and a second polymer material.

Another embodiment of the invention is directed to an optical film that has a polymer matrix layer and polarizing fibers embedded within the matrix layer. At least one of the polarizing fibers has multiple internal birefringent interfaces between a first polymer material and a second polymer material. The optical film substantially reflects normally incident light in a first polarization state and substantially transmits normally incident light, in a second polarization state orthogonal to the first polarization state, with a haze value of at least 10%.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIGS. 1A and 1B schematically illustrate the operation of a polarizer film;

FIG. 2 schematically illustrates a cut-away view of an embodiment of a polymer layer according to principles of the present invention;

FIGS. 3A and 3B schematically illustrate display systems capable of using a polarizer according to principles of the present invention;

FIGS. 4A-4G schematically illustrate cross-sectional views of different embodiments of polarizer films according to principles of the present invention;

FIGS. 5A-5D schematically illustrate cross-sectional views of different exemplary embodiments of polarizing fibers usable in a polarizer film according to principles of the present invention;

FIGS. 5E and 5F schematically illustrate additional exemplary embodiments of polarizing fibers usable in a polarizer film according to principles of the present invention;

FIG. 6 schematically illustrates an embodiment of a polarizing fiber in the form of a yarn;

FIG. 7 schematically illustrates an embodiment of a polarizing fiber in the form of a cable;

FIG. 8 schematically illustrates an embodiment of a tow of polarizing fibers; and

FIG. 9 schematically illustrates an embodiment of a woven fabric that includes polarizing fibers.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to optical systems and is more particularly applicable to polarized optical systems.

As used herein, the terms “specular reflection” and “specular reflectance” refer to the reflectance of light rays from a body where the angle of reflection is substantially equal to the angle of incidence, where the angles are measured relative to a normal to the body's surface. In other words, when the light is incident on the body with a particular angular distribution, the reflected light has substantially the same angular distribution. The terms “diffuse reflection” or “diffuse reflectance” refer to the reflection of rays where the angle of some of the reflected light is not equal to the angle of incidence. Consequently, when light is incident on the body with a particular angular distribution, the angular distribution of the reflected light is different from that of the incident light. The terms “total reflectance” or “total reflection” refer to the combined reflectance of all light, specular and diffuse.

Similarly, the terms “specular transmission” and “specular transmittance” are used herein in reference to the transmission of light through a body where the angular distribution of the transmitted light is substantially the same as that of the incident light. The terms “diffuse transmission” and “diffuse transmittance” are used to describe the transmission of light through a body, where the transmitted light has an angular distribution that is different from the angular distribution of the incident light. The terms “total transmission” or “total transmittance” refer to the combined transmission of all light, specular and diffuse.

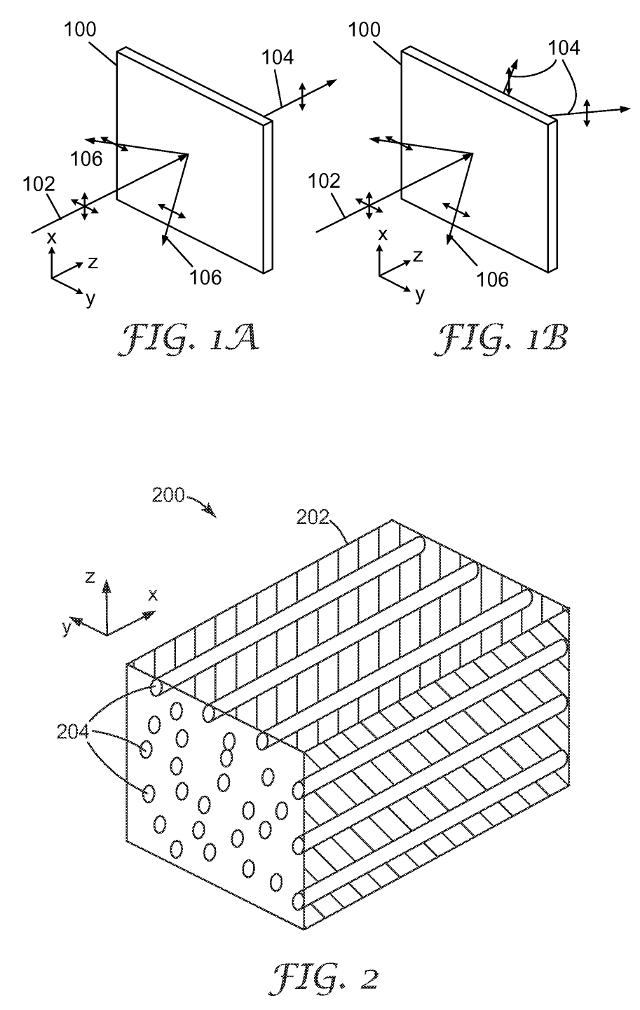

A reflective polarizer film 100 is schematically illustrated in FIGS. 1A and 1B. In the convention adopted herein, the thickness direction of the film is taken as the z-axis, and x-y plane is parallel to the plane of the film. When unpolarized light 102 is incident on the polarizer film 100, the light 104 polarized parallel to the transmission axis of the polarizer film 100 is transmitted, while the light 106 polarized parallel to the reflection axis of the polarizer film 100 is reflected. The angular distribution of the reflected light is dependent on various characteristics of the polarizer 100. For example, the light 106 may be diffusely reflected, as is schematically illustrated in FIG. 1A. Where the polarizer film 100 contains polarizing fibers, the diffusely reflected light is generally scattered asymmetrically, in a direction perpendicular to the axes of the fibers.

In the embodiment illustrated in FIG. 1A, the transmission axis of the polarizer is parallel to the x-axis and the reflection axis of the polarizer 100 is parallel to the y-axis. In other embodiments, these may be reversed. The transmitted light 104 may be specularly transmitted, for example as is schematically illustrated in FIG. 1A, may be diffusely transmitted, for example as is schematically illustrated in FIG. 1B, or may be transmitted with a combination of specular and diffuse components. A polarizer substantially diffusely transmits light when over one half of the transmitted light is diffusely transmitted and substantially specularly transmits light when over one half of the transmitted light is specularly transmitted.

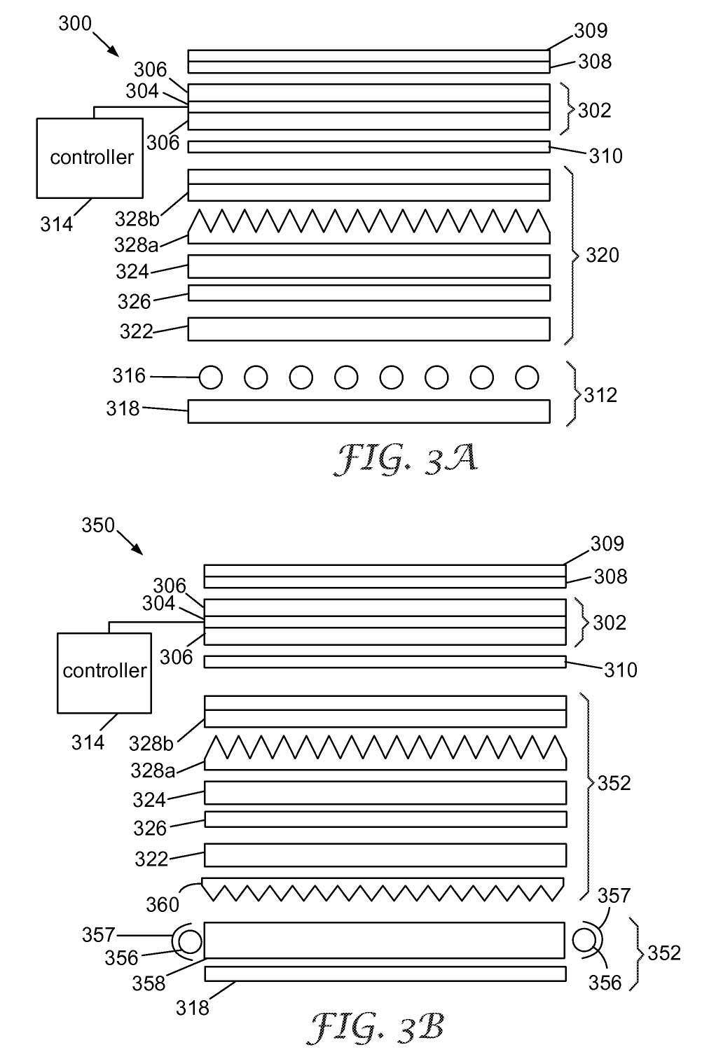

A cut-away view through a reflective polarizer body according to an exemplary embodiment of the present invention is schematically presented in FIG. 2. The body 200 comprises a polymer matrix 202, also referred to as a continuous phase. The polymer matrix may be optically isotropic or optically birefringent. For example, the polymer matrix may be uniaxially or biaxially birefringent, meaning that the refractive index of the polymer may be different along one direction and similar in two orthogonal directions (uniaxial) or different in all three orthogonal directions (biaxial).

Polarizing fibers 204 are disposed within the matrix 202. The polarizing fibers 204 comprise at least two polymer materials, at least one of which is birefringent. In some exemplary embodiments, one of the materials is birefringent while the other material, or materials, is/are isotropic. In other embodiments, two or more of the materials forming the fiber are birefringent. In some embodiments, fibers formed of isotropic materials may also be present within the matrix 202.

The polarizing fibers 204 may be organized within the matrix 202 as single fibers, as illustrated, or in many other arrangements. Some exemplary arrangements include yarns, a tow (of fibers or yarns) arranged in one direction within the polymer matrix, a weave, a non-woven, chopped fiber, a chopped fiber mat (with random or ordered formats), or combinations of these formats. The chopped fiber mat or nonwoven may be stretched, stressed, or oriented to provide some alignment of the fibers within the nonwoven or chopped fiber mat, rather than having a random arrangement of fibers. The formation of a polarizer having an arrangement of polarizing fibers with a matrix is described more fully in U.S. patent application Ser. No. 11/068,157, filed on <date> and incorporated by reference herein.

The refractive indices in the x-, y-, and z-directions for the first fiber material may be referred to as n₁ₓ, n_{1y} and n_{1z}, and the refractive indices in the x-, y-, and z- directions for the second fiber material may be referred to as n₂ₓ, n_{2y} and n_{2z}. Where the material is isotropic, the x-, y-, and z-refractive indices are all substantially matched. Where the first fiber material is birefringent, at least one of the x-, y- and z- refractive indices is different from the others.

Within each fiber 204 there are multiple interfaces formed between the first fiber material and the second fiber material. When at least one of the first and second fiber materials is birefringent, the interface may be referred to as a birefringent interface. For example, if the two materials present their x-and y-refractive indices at the interface, and n₁ₓ≠n_{1y}, i.e. the first material is birefringent, then the interface may be birefringent. Different exemplary embodiments of the polymer fibers containing birefringent interfaces are discussed below.

The fibers 204 are disposed generally parallel to an axis, illustrated as the x-axis in the figure. The refractive index difference at the birefringent interfaces within the fibers 204 for light polarized parallel to the x-axis, n₁ₓ−n₂ₓ, may be different from the refractive index difference for light polarized parallel to the y-axis, n_{1y}−n_{2y}. The interface is said to be birefringent when the difference in refractive index at the interface is different for different directions. Thus, for a birefringent interface, Δnₓ≠Δn_{y}, where Δnₓ=|n₁ₓ−n₂ₓ| and Δn_{y}=|n_{1y}−n_{2y}|.

For one polarization state, the refractive index difference at the birefringent interfaces in the fibers 204 may be relatively small. In some exemplary cases, the refractive index difference may be less than 0.05. This condition is considered to be substantially index-matched. This refractive index difference may be less than 0.03, less than 0.02, or less than 0.01. If this polarization direction is parallel to the x-axis, then x-polarized light passes through the body 200 with little or no reflection. In other words, x-polarized light is highly transmitted through the body 200.

The refractive index difference at the birefringent interfaces in the fibers may be relatively high for light in the orthogonal polarization state. In some exemplary examples, the refractive index difference may be at least 0.05, and may be greater, for example 0.1, or 0.15 or may be 0.2. If this polarization direction is parallel to the y-axis, then y-polarized light is reflected at the birefringent interfaces. Thus, y-polarized light is reflected by the body 200. If the birefringent interfaces within the fibers 204 are substantially parallel to each other, then the reflection may be essentially specular. If, on the other hand, the birefringent interfaces within the fibers 204 are not substantially parallel to each other, then the reflection may be substantially diffuse. Some of the birefringent interfaces may be parallel, and other interfaces may be non-parallel, which may lead to the reflected light containing both specular and diffuse components. Also, a birefringent interface may be curved, or relatively small, in other words within an order of magnitude of the wavelength of the incident light, which may lead to diffuse scattering.

While the exemplary embodiment just described is directed to index matching in the x-direction, with a relatively large index difference in the y-direction, other exemplary embodiments include index matching in the y-direction, with a relatively large index difference in the x-direction.

The polymer matrix 202 may be substantially optically isotropic, for example having a birefringence, n₃ₓ−n_{3y}, of less than about 0.05, and preferably less than 0.01, where the refractive indices in the matrix for the x- and y-directions are n₃ₓ and n_{3y} respectively. In other embodiments, the polymer matrix 202 may be birefringent. Consequently, in some embodiments, the refractive index difference between the polymer matrix and the fiber materials may be different in different directions. For example, the x-refractive index difference, n₁ₓ−n₃ₓ, may be different from the y-refractive index difference, n_{1y}−n_{3y}. In some embodiments, one of these refractive index differences may be at least twice as large as the other refractive index difference.

The magnitude of refractive index difference, the extent and shape of the birefringent interfaces, the relative positions of the birefringent interfaces and the density of birefringent interfaces all affect the scattering, determining whether the scattering is predominantly forwards, backwards, or a combination of the two. Where the refractive index difference for a first polarization state is small compared to the second polarization state, light in the first polarization state may be primarily transmitted specularly or diffusely (forward scattered), while light in the second polarization state is primarily diffusely reflected (back scattered).

Suitable materials for use in the polymer matrix and/or in the fibers include thermoplastic and thermosetting polymers that are transparent over the desired range of light wavelengths. In some embodiments, it may be particularly useful that the polymers be non-soluble in water. Further, suitable polymer materials may be amorphous or semi-crystalline, and may include homopolymer, copolymer or blends thereof. Example polymer materials include, but are not limited to, poly(carbonate) (PC); syndiotactic and isotactic poly(styrene) (PS); C1-C8 alkyl styrenes; alkyl, aromatic, and aliphatic ring-containing (meth)acrylates, including poly(methylmethacrylate) (PMMA) and PMMA copolymers; ethoxylated and propoxylated (meth)acrylates; multifunctional (meth)acrylates; acrylated epoxies; epoxies; and other ethylenically unsaturated materials; cyclic olefins and cyclic olefinic copolymers; acrylonitrile butadiene styrene (ABS); styrene acrylonitrile copolymers (SAN); epoxies; poly(vinylcyclohexane); PMMA/poly(vinylfluoride) blends; poly(phenylene oxide) alloys; styrenic block copolymers; polyimide; polysulfone; poly(vinyl chloride); poly(dimethyl siloxane) (PDMS); polyurethanes; unsaturated polyesters; poly(ethylene), including low birefringence polyethylene; poly(propylene) (PP); poly(alkane terephthalates), such as poly(ethylene terephthalate) (PET); poly(alkane napthalates), such as poly(ethylene naphthalate)(PEN); polyamide; ionomers; vinyl acetate/polyethylene copolymers; cellulose acetate; cellulose acetate butyrate; fluoropolymers; poly(styrene)-poly(ethylene) copolymers; PET and PEN copolymers, including polyolefinic PET and PEN; and poly(carbonate)/aliphatic PET blends. The term (meth)acrylate is defined as being either the corresponding methacrylate or acrylate compounds. With the exception of syndiotactic PS, these polymers may be used in an optically isotropic form.

Several of these polymers may become birefringent when oriented. In particular, PET, PEN, and copolymers thereof, and liquid crystal polymers, manifest relatively large values of birefringence when oriented. Polymers may be oriented using different methods, including extrusion and stretching. Stretching is a particularly useful method for orienting a polymer, because it permits a high degree of orientation and may be controlled by a number of easily controllable external parameters, such as temperature and stretch ratio. The refractive indices for a number of exemplary polymers, oriented and unoriented, are provided in Table I below.

TABLE I
Typical Refractive Index Values for Some Polymer Materials

| Resin/Blend | S.R. | T (° C.) | nₓ | n_{y} | n_{z} |
|---|---|---|---|---|---|
| PEN | 1 | — | 1.64 | | |
| PEN | 6 | 150 | 1.88 | 1.57 | 1.57 |
| PET | 1 | — | 1.57 | | |
| PET | 6 | 100 | 1.69 | 1.54 | 1.54 |
| CoPEN | 1 | — | 1.57 | | |
| CoPEN | 6 | 135 | 1.82 | 1.56 | 1.56 |
| PMMA | 1 | — | 1.49 | | |
| PC, CoPET blend | 1 | — | 1.56 | | |
| THV | 1 | — | 1.34 | | |
| PETG | 1 | — | 1.56 | | |
| SAN | 1 | — | 1.56 | | |
| PCTG | 1 | — | 1.55 | | |
| PS, PMMA copolymer | 1 | — | 1.55–1.58 | | |
| PP | 1 | — | 1.52 | | |
| Syndiotactic PS | 6 | 130 | 1.57 | 1.61 | 1.61 |

PCTG and PETG (a glycol-modified polyethylene terephthalate) are types of copolyesters available from, for example, Eastman Chemical Co., Kingsport, Tenn., under the Eastar™ brand name. THV is a polymer of tetrafluoroethylene, hexafluoropropylene and vinylidene fluoride, available from 3M Company, St. Paul, Minn., under the brand name Dyneon™. The PS/PMMA copolymer is an example of a copolymer whose refractive index may be “tuned” by changing the ratio of the constituent monomers in the copolymer to achieve a desired value of refractive index. The column labeled “S.R.” contains the stretch ratio. A stretch ratio of 1 means that the material is unstretched and unoriented. A stretch ratio of 6 means that sample was stretched to six times it original length. If stretched under the correct temperature conditions, the polymeric molecules are oriented and the material becomes birefringent. It is possible, however, to stretch the material without orienting the molecules. The column labeled “T” indicates the temperature at which the sample was stretched. The stretched samples were stretched as sheets. The columns labeled nₓ, n_{y} and n_{z} refer to the refractive indices of the material. Where no value is listed in the table for n_{y} and n_{z}, the values of n_{y} and n_{z} are the same as for nₓ.

The behavior of the refractive index under stretching a fiber is expected to give results similar to, but not necessarily the same as, those for stretching a sheet. Polymer fibers may be stretched to any desired value that produces desired values of refractive index. For example, some polymer fibers may be stretched to produce a stretch ratio of at least 3, and maybe at least 6. In some embodiments, polymer fibers may be stretched even more, for example to a stretch ratio of up to 20, or even more.

A suitable temperature for stretching to achieve birefringence is approximately 80% of the polymer melting point, expressed in Kelvins. Birefringence may also be induced by stresses induced by flow of the polymer melt experienced during extrusion and film formation processes. Birefringence may also be developed by alignment with adjacent surfaces such as fibers in the film article. Birefringence may either be positive or negative. Positive birefringence is defined as when the direction of the electric field axis for linearly polarized light experiences the highest refractive index when it is parallel to the polymer's orientation or aligning surface. Negative birefringence is defined as when the direction of the electric field axis for linearly polarized light experiences the lowest refractive index when it is parallel to the polymer's orientation or aligning surface. Examples of positively birefringent polymers include PEN and PET. An example of a negatively birefringent polymer includes syndiotactic polystyrene.

The matrix 202 and/or the polymer fibers 204 may be provided with various additives to provide desired properties to the body 200. For example, the additives may include one or more of the following: an anti-weathering agent, UV absorbers, a hindered amine light stabilizer, an antioxidant, a dispersant, a lubricant, an anti-static agent, a pigment or dye, a nucleating agent, a flame retardant and a blowing agent. Other additives may be provided for altering the refractive index of the polymer or increasing the strength of the material. Such additives may include, for example, organic additives such as polymeric beads or particles and polymeric nanoparticles, or inorganic additives, such as glass, ceramic or metal-oxide nanoparticles, or milled, powered, bead, flake or particulate glass, ceramic or glass-ceramic. The surface of these additives may be provided with a binding agent for binding to the polymer. For example, a silane coupling agent may be used with a glass additive to bind the glass additive to the polymer.

In some embodiments, it may be preferable that the matrix 202 or a component of the fibers 204 be non-soluble, or at least resistant to solvents. Examples of suitable materials that are solvent resistant include polypropylene, PET and PEN. In other embodiments it may be preferable that the matrix 202 or component of the polymer fibers 204 is soluble in an organic solvent. For example, a matrix 202 or fiber component formed of polystyrene is soluble in an organic solvent such as acetone. In other embodiments, it may be preferable that the matrix is water soluble. For example, a matrix 202 or fiber component formed of polyvinyl acetate is soluble in water.

The refractive index of the materials in some embodiments of optical element may vary along the length of the fiber, in the x-direction. For example, the element may not be subject to uniform stretching, but may be stretched to a greater degree in some regions than in others. Consequently, the degree of orientation of the orientable materials is not uniform along the element, and so the birefringence may vary spatially along the element.

Furthermore, the incorporation of fibers within the matrix may improve the mechanical properties of the optical element. In particular, some polymeric materials, such as polyester, are stronger in the form of a fiber than in the form of a film, and so an optical element containing fibers may be stronger than one of similar dimensions that contains no fibers.

The fibers 204 may be straight, but need not be straight, for example the fibers 204 may be kinked, spiraled or crimped.

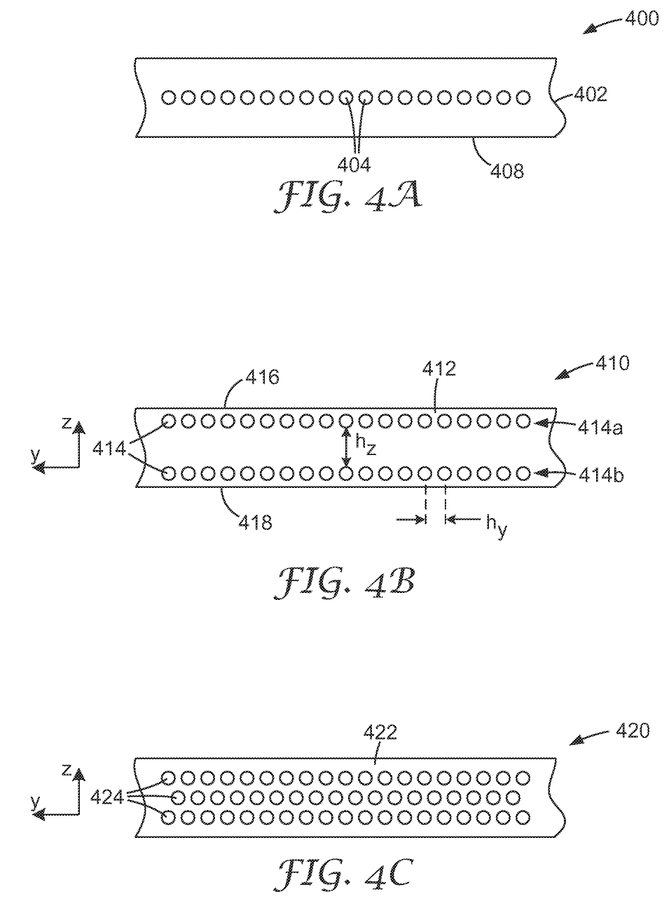

A polarizer layer that transmits light of one polarization, either specularly, diffusely or both, and that reflects light of the orthogonal polarization state, may be used in various types of display system. One type of display system 300 that may use such a polarizer is a direct-lit display system schematically illustrated in FIG. 3A. Such a display system 300 may be used, for example, in an LCD monitor or LCD-TV. The display system 300 may be based on the use of an LC panel 302, which typically comprises a layer of LC 304 disposed between panel plates 306. The plates 306 are often formed of glass, and may include electrode structures and alignment layers on their inner surfaces for controlling the orientation of the liquid crystals in the LC layer 304. The electrode structures are commonly arranged so as to define LC panel pixels, areas of the LC layer where the orientation of the liquid crystals can be controlled independently of adjacent areas. A color filter may also be included with one or more of the plates 306 for imposing color on the image displayed.

An upper absorbing polarizer 308 is positioned above the LC layer 304 and a lower absorbing polarizer 310 is positioned below the LC layer 304. Selective activation of different pixels of the LC layer 304, for example by an attached controller 314, results in the light passing out of the display system 300 at certain desired locations, thus forming an image seen by the viewer. The controller 314 may include, for example, a computer or a television controller that receives and displays television images. One or more optional layers 309 may be provided over the upper absorbing polarizer 308, for example to provide mechanical and/or environmental protection to the display surface. In one exemplary embodiment, the layer 309 may include a hardcoat over the absorbing polarizer 308.

The backlight 312 provides light for the display system 300 behind the LC panel 302. In this embodiment, the backlight 312 includes a number of light sources 316 disposed behind the LC panel 302, in the so-called “direct-lit” configuration. The light sources 316 often used in a LCD-TV or LCD monitor are linear, cold cathode, fluorescent tubes that extend along the height of the display system 300. Other types of light sources may be used, however, such as filament or arc lamps, light emitting diodes (LEDs), flat fluorescent panels or external fluorescent lamps. This list of light sources is not intended to be limiting or exhaustive, but only exemplary.

The backlight 312 may include a reflector 318 for reflecting light propagating downwards from the light sources 316, in a direction away from the LC panel 302. The reflector 318 may also be useful for recycling light within the display system 300, as is explained below. The reflector 318 may be a specular reflector or may be a diffuse reflector. One example of a specular reflector is Vikuiti™ Enhanced Specular Reflection (ESR) film available from 3M Company, St. Paul, Minn. Examples of suitable diffuse reflectors include polymers, such as PET, PC, PP, PS loaded with diffusely reflective particles, such as titanium dioxide, barium sulphate, calcium carbonate or the like.

An arrangement 320 of light management films, which may also be referred to as a light management unit, is positioned between the backlight 312 and the LC panel 302. The light management films affect the light propagating from backlight 312 so as to improve the operation of the display system 300. For example, the arrangement 320 of light management films includes a diffuser plate 322. The diffuser plate 322 is used to diffuse the light received from the light sources, which results in an increase in the uniformity of the illumination light incident on the LC panel 302.

The light management unit 320 may also include a reflective polarizer layer 324. The light sources 316 typically produce unpolarized light but the lower absorbing polarizer 310 only transmits a single polarization state, and so about half of the light generated by the light sources 316 is not transmitted through to the LC layer 304. The reflecting polarizer 324, however, may be used to reflect the light that would otherwise be absorbed in the lower absorbing polarizer, and so this light may be recycled by reflection between the reflecting polarizer 324 and the reflector 318. At least some of the light reflected by the reflecting polarizer 324 may be depolarized, and subsequently returned to the reflecting polarizer 324 in a polarization state that is transmitted through the reflecting polarizer 324 and the lower absorbing polarizer 310 to the LC layer 304. In this manner, the reflecting polarizer 324 may be used to increase the fraction of light emitted by the light sources 316 that reaches the LC layer 304, and so the image produced by the display system 300 is brighter. The reflective polarizer layer may be, for example, a layer like that shown in FIGS. 1A or 1B, and may transmit light specularly, diffusely or with both specular and diffuse components.

A polarization control layer 326 may be provided in some exemplary embodiments, for example between the diffuser layer 322 and the reflective polarizer 324. Examples of polarization control layer 326 include a quarter wave retarding layer and a polarization rotating layer, such as a liquid crystal polarization rotating layer. A polarization control layer 326 may be used to change the polarization of light that is reflected from the reflective polarizer 324 so that an increased fraction of the recycled light is transmitted through the reflective polarizer 324.

The arrangement 320 of light management layers may also include one or more brightness enhancing layers. A brightness enhancing layer is one that includes a surface structure that redirects off-axis light in a direction closer to the axis of the display. This increases the amount of light propagating on-axis through the LC layer 304, thus increasing the brightness of the image seen by the viewer. One example is a prismatic brightness enhancing layer, which has a number of prismatic ridges that redirect the illumination light, through refraction and reflection. Examples of prismatic brightness enhancing layers that may be used in the display device include the Vikuiti™ BEFII and BEFIII family of prismatic films available from 3M Company, St. Paul, Minn., including BEFII 90/24, BEFII 90/50, BEFIIIM 90/50, and BEFIIIT.

The exemplary embodiment shows a first brightness enhancing layer 328a disposed between the reflective polarizer 324 and the LC panel 302. A prismatic brightness enhancing layer typically provides optical gain in one dimension. A second brightness enhancing layer 328b may also be included in the arrangement 320 of light management layers, having its prismatic structure oriented orthogonally to the prismatic structure of the first brightness enhancing layer 328a. Such a configuration provides an increase in the optical gain of the display unit in two dimensions. In other exemplary embodiments, the brightness enhancing layers 328a, 328b may be positioned between the backlight 312 and the reflective polarizer 324.

Another display system 350 is schematically illustrated in FIG. 3B. In this display system, the backlight 352 includes light sources 356 that are positioned to the edge of the display, and a light guide 358 carries the light from the light sources 356 to the a position behind the LC panel 302. This configuration of backlight is often referred to as an “edge-lit’ configuration. Reflectors 357 may be used to increase the amount of light generated by the light sources 357 that is coupled into the light guide 358. Extractors, for example in the form of diffusing patches on the light guide 358, may be provided to extract the light from the light guide 358. The light may either be extracted directly towards the LC panel 302 or may be directed downwards to be reflected towards the LC panel 302 by the reflector 318.

The arrangement 354 of light management films may include layers like those used in a direct-lit configuration, although some layers may be omitted. For example, only a single brightness enhancing layer 328 may be used. Also, the diffuser layer 322 may be omitted. Additionally, the edge-lit display 350 may include a turning film 360 for directing light emitted by the light guide 358 into a direction towards the LC panel 302.

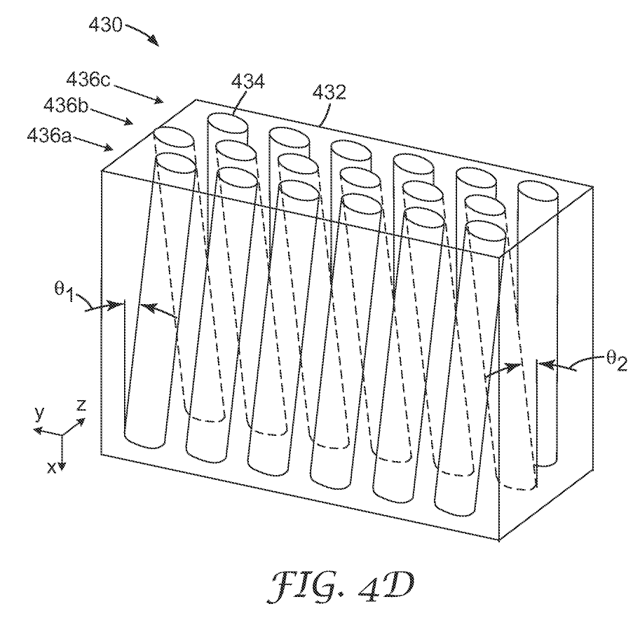

The polarizer layer may include fibers that are arranged within the matrix in many different ways. For example, the fibers may be positioned randomly across the cross-sectional area of the matrix, for example as is shown for fibers 204 in matrix 202, shown in FIG. 2. Other cross-sectional arrangements may be used. For example, in the exemplary embodiment schematically illustrated in FIG. 4A, which shows a cross-section through a reflective polarizer 400, the fibers 404 are arranged in a one-dimensional array within the matrix 402, with regular spacing between adjacent fibers 404. In some variations of this embodiment, the spacing between adjacent fibers 404 need not be the same for all fibers 404. In the illustrated embodiment, the single layer of fibers 404 is positioned midway between the two faces 406, 408 of the element 400. This need not be the case, and the layer of fibers 404 may be positioned closer to either of the faces 406, 408.

In another exemplary embodiment, schematically illustrated in cross-section in FIG. 4B, two layers of fibers 414 are positioned within a matrix 412. The upper layer of fibers 414a is positioned closer to the upper surface 416 while the lower layer of fibers 414b is positioned closer to the lower surface 418. In this particular embodiment, the center-to-center separation between adjacent fibers 414 in the y-direction, h_{y}, is different from the center-to-center separation between adjacent fibers 414 in the z-direction, h_{z}. This need not be the case, and the separation distance in the z-direction, h_{z}, may be the same as the separation distance in the y-direction, h_{y}.

In another embodiment of optical element 420, schematically illustrated in FIG. 4C, three layers of fibers 424 are shown embedded within a matrix 422. Different numbers of fiber layers may be used. In addition, the fibers 424 in different layers may be aligned in the z-direction, for example as shown in FIG. 4B, or may not be aligned in the z-direction. One example of fibers 424 not aligned in the z-direction is element 420, which shows fibers 424 in one layer offset in the y-direction from fibers 424 in an adjacent layer.

While the fibers may all be substantially parallel to the x-axis, this need not be the case, and some fibers may lie with greater or smaller angles to the x-axis. For example, in the example optical element 430 illustrated in FIG. 4D, fibers 434 are embedded within a matrix 432. The first row 436a of fibers 434 may be oriented so as that the fibers 434 lie parallel to each other in a plane parallel to the y-z plane, but at a first angle, θ1, relative to the x-axis. The fibers 434 in the second row 436b may also lie parallel to each other within a plane parallel to the y-z plane, but at a second angle, θ2, to the x-axis, not necessarily equal to the first angle. Also, the fibers 434 in the third row 436c may lie parallel to each other in a plane parallel to the y-z axis, but at a third angle, θ3, relative to the x-axis. The third angle may or may not be equal to either the first or second angles. In the illustrated embodiment, the value of θ3 is equal to zero, and the fibers 434 in the third row 416c are parallel to the x-axis. The different values of θ1, θ2, and θ3 may, however, reach up to 90°.

Such an arrangement may be useful where the fibers in one row are effective for light in a first wavelength band and the fibers in another row are effective for light in a second wavelength band different from the first wavelength band. Consider the illustrative example where the fibers 434 in the first row 436a are effective at reflectively polarizing light in a red bandwidth and the fibers 434 in the second row 436b are effective at reflectively polarizing light in a blue bandwidth. Therefore, where the optical element 430 is illuminated with a mixture of red and blue light, the first row 436a of fibers 434 passes all the blue light while transmitting red light polarized at the angle θ1. The second row 436a of fibers 434 would transmit the red light polarized at the angle θ1 while also transmitting blue light polarized parallel to the angle θ2. Where the angles θ1 and θ2 are separated by 90°, the element 430 transmits red light in one polarization state and blue light in the orthogonal polarization state. Likewise, the reflected blue light is polarized orthogonally to the reflected red light. It will be appreciated that different numbers of rows of fibers 434 may be aligned at each angle, and be used for each color band.

In some embodiments, the density of the fibers may be constant within the optical element or may vary within the optical element. For example, the density of fibers may decrease from one side of the optical element, or may vary in some other manner. In the embodiment schematically illustrated in FIG. 4E, in which a polarizer element 440 has polarizing fibers 444 embedded within a matrix 442, the center-to-center spacing between adjacent fibers 444 in the y-direction is reduced in one region, at the center of the figure, relative to neighboring regions on either side. Consequently, the fill factor, i.e. the fraction of the cross-sectional area of the element 440 taken up by the fibers 444, is increased in that region. The density of the fibers may also very in the y-direction. For example, in the polarizer element 440, the polarizing fibers 444 are more densely packed closer to the lower surface of the polarizer 440, facing the light source 446, than at the upper surface of the polarizer element 440.

Such a variation in the fill factor may be useful, for example, to improve the uniformity of light transmitted through the element 440 from a light source 446. This may be important, for example, where the element 440 is included in a direct view screen lit by discrete light sources: in such devices it is important to present the viewer with an image of uniform illumination. When a light source is placed behind a uniform diffuser, the brightness of the light transmitted through the diffuser is highest above the light source. The variation in fill factor illustrated in FIG. 4E may be used to increase the amount of diffusion directly above the light source 446, thus reducing the non-uniformity in the intensity of the transmitted light.

In other embodiments, some fiber optical property may vary across the optical element. Thus, instead of, or in addition to, the fiber density varying across the optical element, some other property of the fiber may be varied. For example, polarizing fibers that diffusely transmit light more may be used in some regions of the optical element while polarizing fibers that diffusely transmit light less may be used in other portions of the optical element. In other examples, the amount of light back-scattered by a fiber, or the spectrum of the light back-scattered by a fiber, at one position of the optical element may be different from one or more of those properties of a fiber at another position of the optical element. Thus, fiber optical properties that may be varied across the optical element include the amount of diffuse transmission, the amount of backscattering and the back-scattering spectrum.

The optical element may have flat surfaces, for example the flat surfaces parallel to the x-y plane as shown in FIGS. 1A and 1B. The element may also include one or more surfaces that are structured to provide desired optical effects for light transmitted through, or reflected by, the polarizer. For example, in an exemplary embodiment schematically illustrated in FIG. 4F, the optical element 450, formed with a matrix 452 containing polymer fibers 454, may be provided with a prismatically structured surface 456, referred to as a brightness enhancing surface. A brightness enhancing surface is commonly used, for example in backlit liquid crystal displays, to reduce the cone angle of the light illuminating the display panel, and thus increase the on-axis brightness for the viewer. The figure shows an example of two light rays 458 and 459 that are non-perpendicularly incident on the element 450. Light ray 458 is in the polarization state that is transmitted by the element 450, and is also diverted towards the z-axis by the structured surface 456. Light ray 459 is in the polarization state that is diffusely reflected by the element 450. The brightness enhancing surface may be arranged so that the prism structures are parallel to the fibers 454, which is also parallel to the x-axis, as illustrated. In other embodiments, the prism structures may lie at some other angle relative to the direction of the fibers. For example, the ribs may lie parallel to the y-axis, perpendicular to the fibers, or at some angle between the x-axis and the y-axis.

Structured surfaces may be formed on the matrix using any suitable method. For example, the matrix may be cured while its surface is in contact with the surface of a tool, such as a microreplication tool, whose tool surface produces the desired shape on the surface of the polymer matrix. Furthermore, the polarizing fibers 454 may be located within the prismatic surface structures 457.

Another exemplary embodiment of the invention is schematically illustrated in FIG. 4G, in which the element 460 has polymer fibers 464 embedded in a matrix 462. In this particular embodiment, some penetrating elements 466 penetrate through the upper surface 468 of the matrix 462. In some embodiments, the penetrating elements 466 may be fibers, or may assume other shapes, such as spheres. The penetrating elements 466 may direct light 467 towards the axis 469 of the element 460, thus increasing the on-axis brightness.

In different embodiments of polarizer, different fibers within a polarizer may be designed to preferentially reflect light in one polarization state in different wavelength ranges. For example, one set of polarizing fibers within the polarizer may reflect light with a reflectivity peak at a first wavelength while a second set of fibers within the polarizer reflects light with a reflectivity peak at a second wavelength different from the first wavelength. To illustrate, one set of fibers may have a broad reflectivity peak for blue and/or green wavelengths while another set of fibers has a broad reflectivity peak for green and/or red wavelengths. In such a case, the two sets of fibers together may provide polarized reflection over a broad wavelength range.

In addition, the reflection spectrum of different sets of fibers may be set to reflect light at different intensity peaks of the spectrum of light produced by the light sources used in the display system. For example, where the light source generates light having intensity peaks at two different wavelengths, the reflectance spectrum of one set of fibers may be matched to one intensity peak while the reflectance spectrum of another set of fibers is matched to the second intensity peak.

In the different embodiments of polarizer discussed above, and other embodiments encompassed by the invention, some or all of the fibers present in the polarizer layer may be polymeric polarizing fibers. In other embodiments, some of the fibers may be formed of an isotropic material, such as an isotropic polymer or an inorganic material, such as glass, ceramic or glass-ceramic. The use of inorganic fibers in a film is discussed more detail in U.S. patent application Ser. No. 11/125,580, incorporated herein by reference. Inorganic fibers provide additional stiffness to a polarizer layer, and resistance to curling and shape changes under differential conditions of humidity and/or temperature.

In some embodiments, the inorganic fiber material has a refractive index that matches the refractive index of the matrix, and in other embodiments the inorganic fiber has a refractive index that is different from the refractive index of the matrix. Any transparent type of glass may be used, including high quality glasses such as E-glass, S-glass, BK7, SK10 and the like. Some ceramics also have crystal sizes that are sufficiently small that they can appear transparent if they are embedded in a matrix polymer with an index of refraction appropriately matched. The Nextel™ Ceramic fibers, available from 3M Company, St. Paul, Minn., are examples of this type of material, and are already available as thread, yarn and woven mats. Glass-ceramics of interest have compositions including, but not limited to, Li₂O—Al₂O₃—SiO₂, CaO—Al₂O₃—SiO₂, Li₂O—MgO—ZnO—Al₂O₃—SiO₂, Al₂O₃—SiO₂, and ZnO—Al₂O₃—ZrO₂—SiO₂, Li₂O—Al₂O₃—SiO₂, and MgO—Al₂O₃—SiO₂.

In one exemplary embodiment the birefringent material is of a type that undergoes a change in refractive index upon orientation. Consequently, as the fiber is oriented, refractive index matches or mismatches are produced along the direction of orientation. By careful manipulation of orientation parameters and other processing conditions, the positive or negative birefringence of the birefringent material can be used to induce diffuse reflection or transmission of one or both polarizations of light along a given axis. The relative ratio between transmission and diffuse reflection is dependent on a number of factors such as, but not limited to, the concentration of the birefringent interfaces in the fiber, the dimension of the fiber, the square of the difference in the index of refraction at the birefringent interfaces, the size and geometry of the birefringent interfaces, and the wavelength or wavelength range of the incident radiation.

The magnitude of the index match or mismatch along a particular axis affects the degree of scattering of light polarized along that axis. In general, the scattering power varies as the square of the index mismatch. Thus, the larger the mismatch in refractive index along a particular axis, the stronger the scattering of light polarized along that axis. Conversely, when the mismatch along a particular axis is small, light polarized along that axis is scattered to a lesser extent and the transmission through the volume of the body becomes increasingly specular. Diffusion transmission is related to haze, which can be measured by many commercially available haze-meters and is defined according to ASTM D1003. A common tool for measuring haze is the BYK Gardner Haze-Gard Plus (Cat. No. 4725), which defines haze as the fraction of light transmitted that is scattered outside an 8° cone divided by the total amount of light transmitted. In some of the polarizer films according to the present invention, the haze is at least 10%, and may be at least 30% or at least 50%.

If the index of refraction of the non-birefringent material matches that of the birefringent material along some axis, then incident light polarized with electric fields parallel to this axis will pass through the fiber unscattered regardless of the size, shape, and density of the portions of birefringent material. In addition, if the refractive index along that axis is also substantially matched to that of the polymer matrix of the polarizer body, then the light passes through the body substantially unscattered. For purposes of this disclosure, substantial matching between two refractive indices occurs when the difference between the indices is less than at most 0.05, and preferably less than 0.03, 0.02 or 0.01.

If the indices between the birefringent material and non-birefringent material are not matched along some axis, then the fiber scatters or reflects light polarized along this axis. The strength of the scattering is determined, at least in part, by the magnitude of the index mismatch for scatterers having a given cross-sectional area with dimensions larger than approximately λ/30, where A is the wavelength of the incident light in the polarizer. The exact size, shape and alignment of a mismatched interface play a role in determining how much light will be scattered or reflected into various directions from that interface. If the density and thickness of the scattering layer is sufficient, according to multiple scattering theory, incident light will be either reflected or absorbed, but not transmitted, regardless of the details of the scatterer size and shape.

Prior to use in the polarizer, the fibers are preferably processed by stretching and allowing some dimensional relaxation in the cross stretch in-plane direction, so that the index of refraction difference between the birefringent material and the non-birefringent materials are relatively large along a first axis and small along the other two orthogonal axes. This results in a large optical anisotropy for electromagnetic radiation of different polarizations.

Some of the polarizers within the scope of the present invention are elliptically diffusing polarizers. In general, elliptically diffusing polarizers use fibers having a difference in index of refraction between the birefringent and non-birefringent materials along both the stretch and non-stretch directions, and may diffusely transmit or reflect light of one polarization. The birefringent material in the fiber may also form birefringent interfaces with the polymer matrix material, in which case these interfaces may also include an index mismatch for both the stretch and cross-stretch directions.

The ratio of forward-scattering to back-scattering is dependent on the difference in refractive index between the birefringent and non-birefringent materials, the concentration of the birefringent interfaces, the size and shape of the birefringent interfaces, and the overall thickness of the fiber. In general, elliptical diffusers have a relatively small difference in index of refraction between the birefringent and non-birefringent materials.

The materials selected for use in the fibers in accordance with the present invention, and the degree of orientation of these materials, are preferably chosen so that the birefringent and non-birefringent materials in the finished fiber have at least one axis for which the associated indices of refraction are substantially equal. The match of refractive indices associated with that axis, which typically, but not necessarily, is an axis transverse to the direction of orientation, results in substantially no reflection of light at the internal fiber interfaces in that plane of polarization. A degree of intentional mismatching of refractive index for this plane, however, may be used to create some degree of light diffusion, as described elsewhere

One exemplary embodiment of a polarizing fiber that has internal birefringent interfaces, and that may be used in some embodiments of polarizer discussed above, is a multilayer polarizing fiber. A multilayer fiber is a fiber that contains multiple layers of different polymer materials, at least one of which is birefringent. In some exemplary embodiments, the multilayer fiber contains a series of alternating layers of a first material and a second material, where at least one of the materials is birefringent. In some embodiments, the first material has a refractive index along one axis about the same as that of the second material and the refractive index along an orthogonal axis different from that of the second material. Such structures are discussed at greater length in, for example, U.S. Pat. No. 5,882,774, incorporated herein by reference.

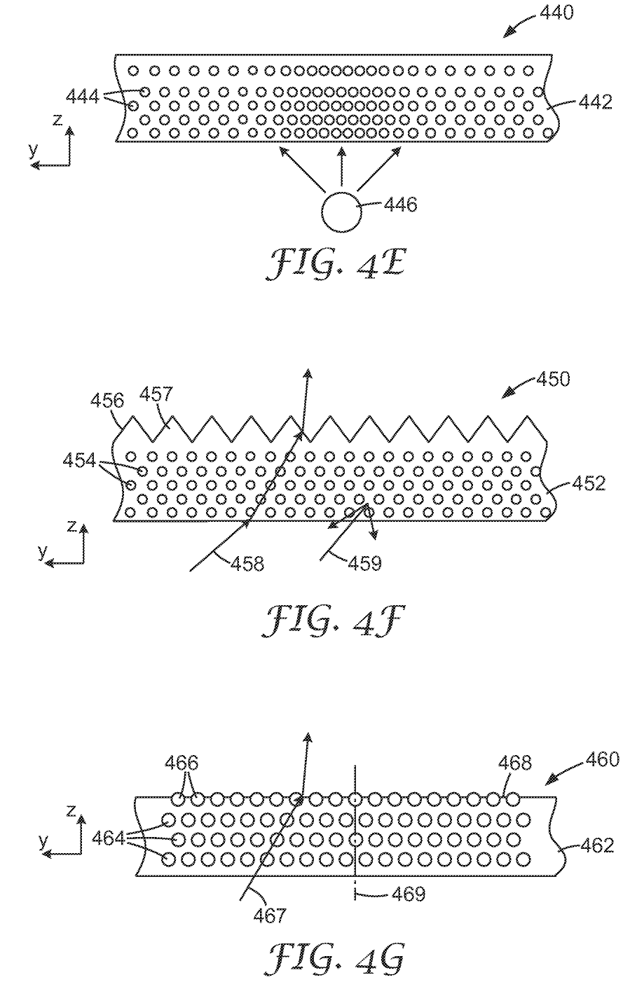

A cross-section through one exemplary embodiment of a multilayer polarizing fiber 500 is schematically illustrated in FIG. 5A. The fiber 500 contains alternating layers of a first material 502 and a second material 504. The first material is birefringent and the second material is substantially isotropic, so that the interfaces 506 between adjacent layers are birefringent. In this particular embodiment, the interfaces 506 are substantially planar, and extend along the length of the fiber 500.

The fiber 500 may be surrounded by a cladding layer 508. The cladding layer 508 may be made of the first material, the second material, the material of the polymer matrix in which the fibers are embedded, or some other material. The cladding may functionally contribute to the performance of the overall device, or the cladding may perform no function. The cladding may functionally improve the optics of the reflective polarizer, such as by minimizing the depolarization of light at the interface of the fiber and the matrix. Optionally, the cladding may mechanically enhance the polarizer, such as by providing the desired level of adhesion between the fiber and the continuous phase material. In some embodiments, the cladding 508 may be used to provide an antireflection function, for example by providing some refractive index matching between the fiber 400 and the surrounding polymer matrix.

The fiber 500 may be formed with different numbers of layers and with different sizes, depending on the desired optical characteristics of the fiber 500. For example, the fiber 500 may be formed with from about ten layers to hundreds of layers, with an associated range in thickness. There is no limitation on the width of the fiber 500, although preferred values of the width may fall in a range from 5 μm to about 5000 μm, although the fiber width may also fall outside this range.

A multilayer fiber 500 may be fabricated by coextruding multiple layers of material into a multilayer film, followed by a subsequent step of stretching so as to orient the birefringent material and produce birefringent interfaces. Multilayer fibers may be obtained by slicing a multilayer sheet. Some approaches to manufacturing multilayer sheets containing birefringent interfaces are described further, for example, in U.S. Pat. Nos. 5,269,995; 5,389,324; and 5,612,820, incorporated by reference.

Some examples of suitable polymer materials that may be used as the birefringent material include PET, PEN and various copolymers thereof, as discussed above. Some examples of suitable polymer materials that may be used as the non-birefringent material include the optically isotropic materials discussed above.

Other configurations of multilayer fiber may be used. For example, another exemplary embodiment of multilayer fiber 520 may be formed with concentric layers of alternating first material 522 and second material 524, where the first material 522 is birefringent and the second material 524 may be either isotropic or birefringent. In this exemplary embodiment, the fiber 520 includes concentric birefringent interfaces 526, between the alternating layers 522, 524, that extend along the fiber 520.

The outer layer 528 of the fiber 520 may be formed of one of the first and second material, the same polymer material as is used in the polymer matrix of the polarizer, or some other material.

The fiber 520 may be formed with any suitable number of layers and layer thicknesses to provide desired optical characteristics, such as reflectivity and wavelength dependence. For example, the concentric fiber 520 may contain from around ten layers to hundreds of layers. The concentric fiber 520 may be formed by coextruding a multilayer form followed by stretching to orient the birefringent material. Any of the materials listed above for use in the flat multilayer fiber 500 may also be used in the concentric fiber 520.

Multilayer fibers having different types of cross-sections may also be used. For example, concentric fibers need not be circular in shape and may have some other shape, such as elliptical.

Another exemplary embodiment of a multilayer polarizing fiber is a spiral wound fiber, described in greater detail in U.S. patent application Ser. No. 11/278,348, incorporated herein by reference. An exemplary embodiment of a spiral wound fiber is schematically illustrated in FIG. 5C. In this embodiment, the fiber 530 is formed like a two-layer sheet 532 that is wound around itself to form a spiral. The two layer sheet contains a layer of a first polymer material that is birefringent and a second layer of a second material that may be isotropic or birefringent. The birefringent polymer material(s) may be oriented before or after the fiber is formed. The interfaces 534 between adjacent layers are interfaces between a birefringent material and another material, and so are considered birefringent interfaces. In other embodiments, more than two layers may be formed in a spiral. Such fibers may be formed using several different methods, including winding a multilayer sheet and co-extrusion.

Another exemplary embodiment of a polarizing fiber having internal birefringent interfaces is a composite polarizing fiber, which contains multiple scattering fibers infiltrated with a polymer filler. An example of a cross-section through an exemplary composite polarizing fiber 540 is schematically illustrated in FIG. 5D. The composite polarizing fiber 540 includes multiple scattering fibers 542 with a filler 544 between the scattering fibers 542. In some embodiments, at least one of the scattering fibers 542 or the filler 544 is birefringent. For example, in some exemplary embodiments, at least some of the scattering fibers 542 may be formed of a birefringent material and the filler material 544 may be non-birefringent. In other exemplary embodiments, the scattering fibers 542 may be non-birefringent while the filler material 544 is birefringent. In other embodiments, both the scattering fibers 542 and the filler 544 may be birefringent. In these different variations, each interface 546 between the material of a scattering fiber 542 and the filler material 544 is an interface between a birefringent material and another material, i.e. is a birefringent interface, and can contribute to the preferential reflection or scattering of light in a selected polarization state.

Composite polarizing fibers are described further in U.S. patent application Ser. No. 11/068,157. A composite polarizing fiber can take on different cross-sectional shapes and may be, for example, circular as shown in FIG. 5D, or may be elliptical, square, rectangular or some other shape. Additionally, the scattering fibers 542 need not be circular in cross section. A composite fiber may optionally be provided with an outer layer 548 that may be used for reasons as discussed above.

The positions of the scattering fibers 542 within the cross-section of the composite fiber may be random, although other cross-sectional arrangements of the scattering fibers 542 may be used. For example, the scattering fibers 542 may be regularly arranged within the cross-section of the composite polarizing fiber 540, for example as discussed in U.S. patent application Ser. No. 11/068,157. and U.S. patent application Ser. No. 11/068,158, incorporated herein by reference. In some embodiments, the scattering fibers 542 may be arranged to form a photonic crystal for light incident on the polarizer. Additionally, the scattering fibers 542 and/or the composite fibers 540 need not all be of the same size, or may vary in size along their lengths.

Another method for generating the desired internal structure that contains polymer birefringent interfaces in a fiber is to use two polymers which are not miscible, where at least one of the polymers is birefringent. The polymers may be coextruded, cast, or otherwise formed into a fiber. Upon processing, a continuous phase and a dispersed phase are generated. With subsequent processing or orientation, the dispersed phase can assume rod-like or layered structures, depending on the internal structure of the polymer fiber. Furthermore, the polymer materials may be oriented so that there is substantial refractive index matching between the two materials for one polarization direction and a relatively large index mismatch for the other polarization. The generation of a dispersed phase in a film matrix is described in greater detail in U.S. Pat. No. 6,141,149, included herein by reference.

This type of birefringent polymer fiber may be referred to as a dispersed phase polarizing fiber. An example of a dispersed phase polarizing fiber 550 is schematically illustrated in FIG. 5E, the dispersed phase 552 being located within the continuous phase 554. The cross-section shows the random distribution of dispersed phase portions 552 across the cross-section of the fiber 550. The interfaces between the matrix 554 and the dispersed phase 552 are birefringent interfaces, and so polarization sensitive reflection or scattering occurs at the interfaces.

The dispersed phase may also be formed of liquid crystal droplets, liquid crystal polymers or polymers. The dispersed phase could, alternatively, be comprised of air (microvoids). In any case, the interfaces between the dispersed and continuous phases within the dispersed phase fiber can induce desired optical properties, including reflective polarization.

In another approach to forming a birefringent polymer fiber, a fiber may be formed in a manner similar to a composite fiber, with a first polymer being used as the filler, but with second and third polymers being used for the scattering fibers. In some embodiments, the second and third polymers are not miscible with each other, and at least one of the second and third polymers is birefringent. The second and third polymers may be mixed as extruded as scattering fibers in a composite fiber. Upon processing, the first polymer forms the filler portion of the composite fiber, and the scattering fibers contain both a continuous phase and a dispersed phase, from the second and third polymers, respectively. This type of fiber is referred to as a dispersed phase composite fiber. An example of a dispersed phase composite fiber 560 is schematically illustrated in FIG. 5F, showing scattering fibers 562 that include disperse phases 564. The scattering fibers 562 are surrounded by the filler 566. In other embodiments, the scattering fibers may be formed of a second polymer and a third material, where the third material is a liquid crystal material, a liquid crystal polymer or a polymer.

Similarly, the concentric multilayer fiber and non-concentric multilayer fibers may be made of alternating layers with one of the layer types comprised of a first polymer and the second layer type comprised of a mixture of two polymers or materials which are not miscible. Upon processing in those cases, alternating layers are produced with some layers comprising the first polymer and some other layers comprising both a dispersed phase and a continuous phase. Preferably, one or both of the continuous phase and the dispersed phase are birefringent. With subsequent processing or orientation, the dispersed phase in the second type of layers can assume rod-like or layered structures.

The size requirements for the scattering fibers or birefringent regions in a layered fiber are similar among all the various embodiments. The size of the fiber or thickness of a layer in a multilayer device can be scaled up or down appropriately to achieve the desired size scale for the systems comprising layers or fibers containing a continuous and disperse phase, dependent on the desired operating wavelength or wavelength range. In some embodiments that include quarter-wave multilayered fibers, requirements of reflectivity and wavelength may determine the cross-sectional size of a fiber.

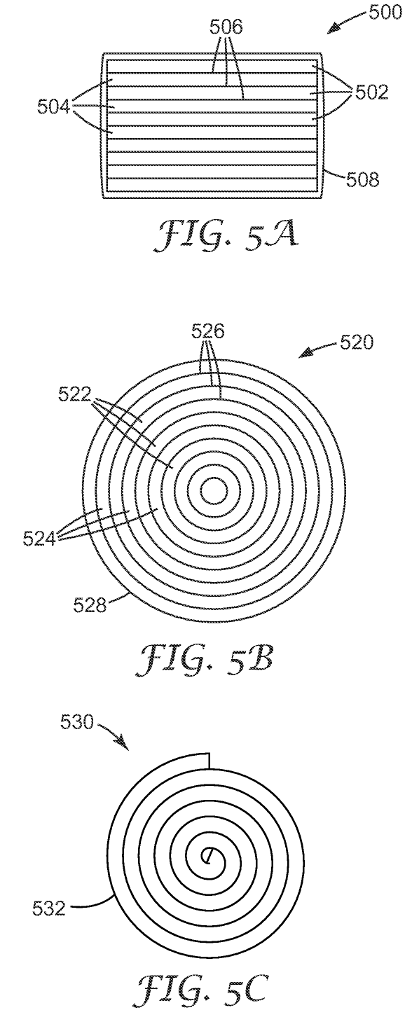

Another type of polymer fiber that may be used in a polarizer of the present invention is now described with reference to FIG. 6. The fiber is formed as a yarn 600. In some embodiments of the yarn 600, the fiber is formed of a number of fibers 602 twisted together, for example by twisting together a number of multilayer fibers, disperse phase fibers, composite fibers, disperse phase composite fibers and/or inorganic fibers. The yarn 600 may be formed by twisting one or more oriented fibers to form the yarn, or may be formed by twisting isotropic polymer fibers together, where the fibers are made of an orientable material, and then stretching the yarn 600 to orient the orientable material.

The yarn 600 may include lengths of fiber, commonly referred to as staple fiber, that do not extend over the entire length of the yarn 600. The yarn 600 may be encapsulated within the polymer matrix, with the matrix filling the spaces between the fibers 602 that comprise the yarn 600. In other embodiments, the yarn 600 may have a filler between the fibers 602.

In general, the birefringent interfaces of the polymer fibers are elongated, extending in a direction along the fibers. In some exemplary embodiments, the birefringent fibers lie parallel to the x-axis, and so the diffusely reflected light is scattered mostly into the plane perpendicular to the fibers, the y-z plane, and there is little scattering in the x-z-plane.

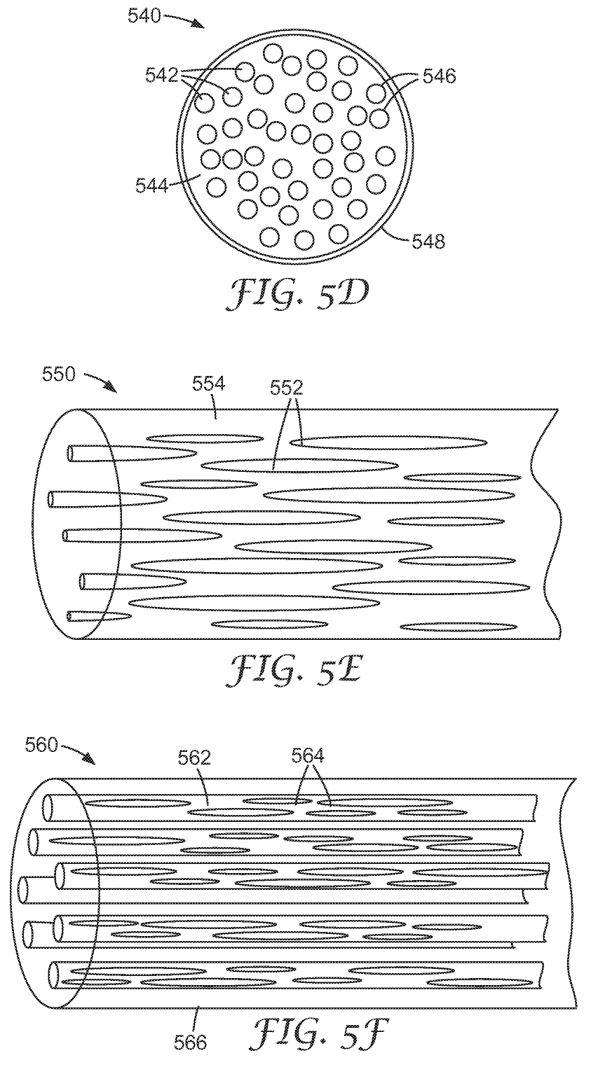

Another embodiment of yarn 700, schematically illustrated in FIG. 7, is characterized by a number of polymer fibers 702 wrapped around a central fiber core 704. The central fiber 704 may be an inorganic fiber or an organic fiber. A yarn, such as yarn 700, which includes both inorganic and polymer fibers, may be used to provide particular optical properties associated with the polymer fibers 702 while also providing the strength of the inorganic central fiber 704. For example, the polymer fibers may be polarizing fibers.

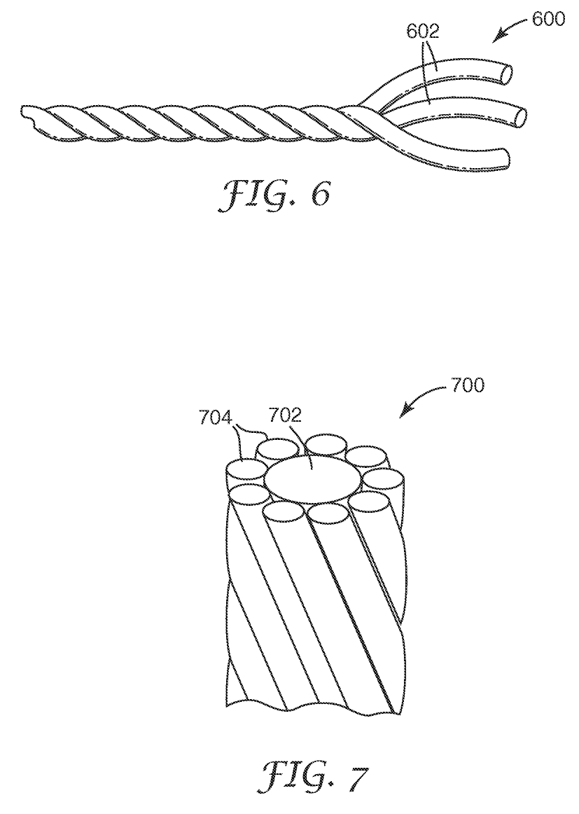

The fibers may be included in the polymer matrix in the form of a tow, a parallel-type arrangement of fibers or yarns that are discrete. The fibers in the tow can be composite fibers, multilayer fibers, fiber yarn, any other suitable type of fibers, inorganic fibers, or a combination thereof. In particular, the tow or tows may form a set of fibers or yarns that are substantially parallel to each other. An embodiment of a fiber tow 800 is schematically illustrated in FIG. 8. Cross-members 804 may be present to provide support to the fibers 802 and to keep the fibers 802 at a desired spacing relative to their neighbors prior to being embedded within the matrix. The cross members 804 may be formed using other fibers, a bead of adhesive, or the like.

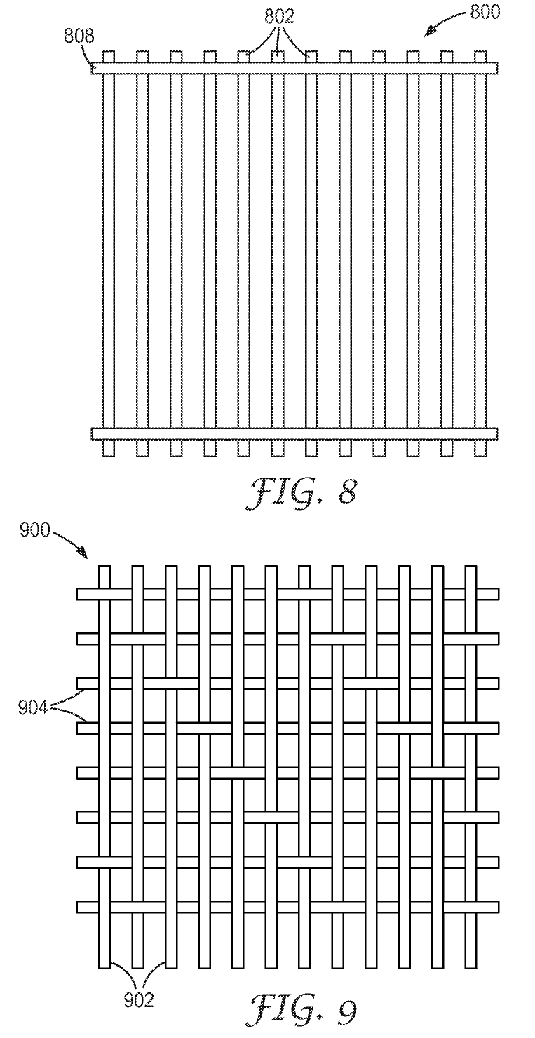

The fibers may also be included in the matrix in the form of one or more fiber weaves. A weave 900 is schematically illustrated in FIG. 9. Polarizing fibers may form part of the warp 902 and/or part of the weft 904. Inorganic fibers may be included in the weave and may also form part of the warp 902 and/or the weft 904. Additionally, some of the fibers of the warp 902 or weft 904 may be isotropic polymer fibers. The weave 900 employs a five harness satin weave, although different types of weaves may be used, for example other types of satin weaves, plain weaves and the like.

In some embodiments, more than one weave may be included within a matrix. For example, a polarizer film may include one or more weaves that contain polarizing fibers and one or more weaves that contain only inorganic fibers. In other embodiments, different weaves may include both polarizing fibers and inorganic fibers.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. An optical display system, comprising:
a display panel;
at least one light source for producing light to illuminate the display panel; and
one or more light management films disposed between the light source and the display panel, the one or more light management films comprising at least a polarizer film, the polarizer film comprising polarizing fibers embedded within a matrix, at least one of the polarizing fibers comprising multiple internal birefringent interfaces between a first polymer material and a second polymer material.

2. A system as recited in claim 1, wherein the display panel comprises a liquid crystal display panel and a controller coupled to the display panel for controlling an image displayed by the display panel.

3. A system as recited in claim 1, wherein the polarizer layer substantially diffusely transmits light of a first polarization state and substantially reflects light in a second polarization state orthogonal to the first polarization state.

4. A system as recited in claim 1, wherein the polarizer layer substantially specularly transmits light of a first polarization state and substantially reflects light in a second polarization state orthogonal to the first polarization state.

5. A system as recited in claim 1, wherein the at least one of the polarizing fibers comprising multiple internal birefringent interfaces comprises a multilayered fiber.

6. A system as recited in claim 5, wherein the multilayered fiber comprises one of substantially planar layers of the first and second polymer materials and concentric layers of the first and second polymer materials.

7. A system as recited in claim 1, wherein the at least one of the polarizing fibers comprising multiple internal birefringent interfaces comprises a spiral wound fiber.

8. A system as recited in claim 1, wherein the at least one of the polarizing fibers comprising multiple internal birefringent interfaces comprises a composite polarizing fiber having multiple scattering fibers formed of a first polymer material disposed within filler material.

9. A system as recited in claim 1, wherein the at least one of the polarizing fibers comprising multiple internal birefringent interfaces comprises a disperse fiber having a disperse phase of a first polymer material disposed within a second polymer material.

10. A system as recited in claim 1, wherein the polarizing fibers comprise polymer fiber yarn.

11. A system as recited in claim 1, further comprising inorganic fibers disposed within the polymer matrix.

12. A system as recited in claim 1, further comprising at least one of a fiber weave and a fiber tow disposed within the polymer matrix, the at least one of a fiber weave and a fiber tow comprising the polarizing fibers.

13. A system as recited in claim 1, further comprising at least one of a chopped fiber mat and chopped fiber disposed within the polymer matrix, the at least one of a chopped fiber mat and chopped fiber comprising the polarizing fibers.

14. A system as recited in claim 1, wherein the polarizing fibers are not uniformly spaced apart in a direction parallel to a surface of the polarizer film.

15. A system as recited in claim 20, wherein the density of the polarizing fibers within the polarizer film is relatively high at a region of the polarizer film close to the light source.

16. A system as recited in claim 1, further comprising a backlight, the backlight comprising the at least one light source.

17. A system as recited in claim 1, wherein the polarizer film comprises a structured surface.

18. A system as recited in claim 17, wherein the structured surface of the polarizer is a brightness enhancing surface.

19. A system as recited in claim 1, wherein the polarizing fibers comprise a first set of polarizing fibers oriented in a first direction within the matrix and a second set of polarizing fibers oriented in a second direction within the matrix different from the first direction.

20. A system as recited in claim 1, wherein the polarizing fibers comprise a first set of polarizing fibers having a reflectivity peak selected for a first wavelength and a second of fibers having a reflectivity peak selected for a second wavelength different from the first wavelength.

21. A system as recited in claim 20, wherein the at least one light source generates light at the first and second wavelengths.

22. A system as recited in claim 20, wherein the at least one light source generates light having a first intensity peak at approximately the first wavelength and a second intensity peak at approximately the second wavelength.

23. A system as recited in claim 20, wherein the first and second sets of polarizing fibers are reflective for one polarization state of light having a wavelength range overlapping the wavelength range of light produced by the at least one light source.

24. A system as recited in claim 1, wherein at least a first of the polarizing fibers has fiber optical properties different from at least a second of the polarizing fibers, the fiber optical properties comprising amount of diffuse transmission, amount of back-scattering and back-scattering spectrum.

25. A system as recited in claim 1, wherein the polarizer film substantially reflects normally incident light in a first polarization state and substantially transmits normally incident light, in a second polarization state orthogonal to the first polarization state, with a haze value of at least 10%

26. An optical film, comprising:
a polymer matrix layer; and
polarizing fibers embedded within the matrix layer, at least one of the polarizing fibers comprising multiple internal birefringent interfaces between a first polymer material and a second polymer material;
wherein the optical film substantially reflects normally incident light in a first polarization state and substantially transmits normally incident light, in a second polarization state orthogonal to the first polarization state, with a haze value of at least 10%.

27. An optical film as recited in claim 26, wherein at least one of the polarizing fibers comprising multiple internal birefringent interfaces comprises a multilayered fiber.

28. An optical film as recited in claim 27, wherein the multilayered fiber comprises one of substantially planar layers and concentric layer of the first and second polymer materials.

29. An optical film as recited in claim 26, wherein at least one of the polarizing fibers comprising multiple internal birefringent interfaces comprises a spiral wound fiber.

30. An optical film as recited in claim 26, wherein at least one of the polarizing fibers comprising multiple internal birefringent interfaces comprises a composite polarizing fiber having multiple scattering fibers formed of a first polymer material disposed within filler material.

31. An optical film as recited in claim 26, wherein at least one of the polarizing fibers comprising multiple internal birefringent interfaces comprises a disperse fiber having a disperse phase of a first polymer material disposed within a second polymer material.

32. An optical film as recited in claim 26, wherein the polarizing fibers comprise polymer fiber yarn.

33. An optical film as recited in claim 26, further comprising inorganic fibers disposed within the polymer matrix layer.

34. An optical film as recited in claim 26, further comprising a at least one of a fiber weave and a fiber tow disposed within the polymer matrix layer, the at least one of a fiber weave and a fiber tow comprising the polarizing fibers.

35. An optical film as recited in claim 26, further comprising at least one of a chopped fiber mat and chopped fiber disposed within the polymer matrix layer, the at least one of a chopped fiber mat and chopped fiber comprising the polarizing fibers.

36. An optical film as recited in claim 26, wherein the polarizing fibers are not uniformly spaced apart in a direction parallel to a surface of the polarizer film.

37. An optical film as recited in claim 26, wherein the matrix layer has a structured surface.

38. An optical film as recited in claim 26, wherein the polarizing fibers comprise a first set of polarizing fibers oriented in a first direction within the matrix and a second set of polarizing fibers oriented in a second direction within the matrix different from the first direction.

39. An optical film as recited in claim 26, wherein the polarizing fibers comprise a first set of polarizing fibers having a reflectivity peak selected for a first wavelength and a second of fibers having a reflectivity peak selected for a second wavelength different from the first wavelength.

40. An optical film as recited in claim 26, wherein at least a first of the polarizing fibers has fiber optical properties different from at least a second of the polarizing fibers, the fiber optical properties comprising amount of diffuse transmission, amount of back-scattering and back-scattering spectrum.
